(19) United States
(12) Patent Application Publication
(10) Pub. No.: US 2003/0215173 A1
(43) Pub. Date: Nov. 20, 2003

(54) Multiphase optical pulse generator

(76) Inventors: Farhad Hakimi, Watertown, MA (US); Hosain Hakimi, Watertown, MA (US)

Correspondence Address: Iandiorio & Teska, 260 Bear Hill Road, Waltham, MA, 02451-1018, US

(21) Appl. No.: 10/193,746

(22) Filed: Jul. 11, 2002

Related U.S. Application Data
(60) Provisional application No. 60/380,364, filed on May 14, 2002.

(51) Int. Cl. G02B 6/26

(52) U.S. Cl. 385/15

(57) ABSTRACT

A multiphase optical pulse generator for selective side band suppression of a pulse stream includes an unbalanced interferometer responsive to a pulse of the pulse stream to generate at least first and second replica pulses, a delay device for delaying the replica pulses relative to each other to define a free spectral range to include only one or both of a pair of selected spectral side bands to be suppressed, a phase shifting device for shifting the phase of the replica pulses relative to each other to align the free spectral range and create a combined multiphase pulse to suppress only one or both of the selected spectral side bands.

### RELATED APPLICATIONS

This application claims priority of U.S. Provisional Application entitled GNEERATION OF PULSES THAT RESIST OR PREVENT NON LINEAR EFFECTS IN OPTICAL FIBERS, Hakimi et al., Serial No. 60/380,364, filed May 14, 2002.

### FIELD OF THE INVENTION

This invention relates to a multiphase optical pulse generator for selected side band suppression of a pulse stream.

### BACKGROUND OF THE INVENTION

Optical fiber transmission using optical pulses such as in return-to-zero (RZ), non-return-to-zero (NRZ), carrier suppressed return-to-zero (CS RZ), single side band suppression (SSB), and other formats are always subject to detrimental effects caused by intensity dependent non-linear index of refraction of the fiber. This dependency leads to non-linear phenomena such as pulse spectral broadening called self phase modulation (SPM) for a single channel and cross talk such as four wave mixing (FWM) and cross phase modulation (XPM) in mulltichannels wavelength division multiplexing (WDM) systems involving many different colors or wavelengths of light.

One way to avoid these non-linear effects is to reduce the pulse launched power or intensity in the fiber. This leads to reduced signal to noise for optical channels and elevated amplified spontaneous noise (ASE) from the optical amplifiers in the link. This reduction in signal-to-noise usually requires more sophisticated methods to recover the signals at the receiver. One such method is forward error correction (FEC) and the other uses distributed Raman amplification which is generally believed to achieve lower non-linear effects and noise in optical fiber transmission. However, the cost and complexity of implementation of such methods force the system designers to seek alternate and simpler techniques.

These effects can be reduced somewhat using either a suppressed carrier approach or a single side band technique by narrowing the bandwidth. This approach uses electronic means to shift the phase of the pulses so each pulse is followed by another pulse of opposite phase to reduce one set of side bands. While this works at lower data rates, it falls short at higher data rates beyond 10 Gb/s because of the difficulty and limitation of electronic circuits.

### BRIEF SUMMARY OF THE INVENTION

It is therefore an object of this invention to provide a multiphase optical pulse generator for selected side band suppression of a pulse stream.

It is a further object of this invention to provide such a multiphase optical pulse generator which is simpler and more effective.

It is a further object of this invention to provide a multiphase optical pulse generator which functions optically and can operate easily at high data repetition rates of 40 GHz and higher.

It is a further object of this invention to provide a multiphase optical pulse generator which reduces pulse spectral broadening such as self phase modulation for a single channel and reduces cross talk such as from wave mixing and cross phase modulation in multichannel wavelength division multiplexing systems involving many different colors or wavelengths of light.

It is a further object of this invention to provide a multiphase optical pulse generator which produces a temporarily broader resulting multiphase pulse less susceptible to spectral spreading.

It is a further object of this invention to provide a multiphase optical pulse generator which is applicable to return-to-zero (RZ), non- return-to-zero (NRZ), carrier suppressed return-to-zero (CS RZ), single side band suppression (SSB), and other formats.

The invention results from the realization that simpler and more effective side band suppression of one or both of a pair of side bands can be achieved by using an unbalanced interferometer to generate two or more replica pulses from a pulse of a pulse stream, then delaying a first replica pulse relative to a second to define a free spectral range to include only one or both of a pair of spectral side bands to be suppressed and phase shifting the second replica pulse relative to the first to align the free spectral range with both or with the one but not the other of the pair of side bands and create a combined multiphase pulse to suppress the selected side band(s).

This invention features a multiphase optical pulse generator for selective side band suppression of a pulse stream. There is an unbalanced interferometer responsive to a pulse of the pulse stream to generate at least first and second replica pulses and a delay device for delaying the replica pulses relative to each other to define a free spectral range to include only one or both of a selected spectral side band to be suppressed. A phase shifting device shifts the phase of the replica pulses relative to each other to align the free spectral range and create a combined multiphase pulse to suppress the only one or both of the selected spectral side bands.

In a preferred embodiment, the interferometer may be a Mach Zehnder interferometer, a Michelson interferometer, or a Fabry-Perot etalon in reflection. The multiphase optical pulse generator may include an input coupler for generating the replica pulses and it may include an output coupler for recombining the delayed and phase shifted replica pulses into the multiphase pulse. The interferometer may include a first beam splitter for generating the replica pulses, a second beam splitter for recombining the replica pulses, a first mirror for directing the first replica pulse over a delay path to a second mirror which directs the first replica pulse to the second beam splitter and a polarization rotator between the first and second beam splitter to shift the phase of the second replica pulse relative to the first replica pulse. The polarization rotator may include a half wave plate. The interferometer may include a birefringent optical medium. The birefringent optical medium may resolve an incoming pulse into time delayed orthogonal replica pulses. The interferometer may include a polarizer for phase shifting the orthogonal replica pulses and combining them into a multiphase pulse.

### BRIEF DESCRIPTION OF THE DRAWINGS

Other objects, features and advantages will occur to those skilled in the art from the following description of a preferred embodiment and the accompanying drawings, in which:

FIG. 1 is a schematic block diagram of a prior art optical transmitter including a continuous wave laser and optical carrier modulator and the resulting output;

FIG. 2 is a schematic block diagram of a prior art optical transmitter including a continuous wave laser, optical carrier modulator, the resulting output, and data modulator and the resulting output;

FIG. 3 is a schematic block diagram of a prior art optical transmitter similar to that of FIG. 2 operating in a single side band mode and the resulting output;

FIG. 4 is a schematic block diagram of an optical transmitter including a multiphase pulse generator according to this invention and the resulting output;

FIG. 5 is a schematic block diagram of a typical interferometer and the variation in spectral range size of the output transform resulting from variations in the delay between the optical inputs;

FIG. 6 is a more detailed schematic diagram of an optical multiphase pulse generator according to this invention;

FIG. 7 is a more detailed schematic diagram of an optical multiphase pulse generator according to this invention employing two cascaded interferometers;

FIG. 8 is a simplified schematic diagram of an optical multiphase pulse generator using a delay line with a polarization rotator device according to this invention;

FIG. 9 is a simplified schematic diagram of an optical multiphase pulse generator using a birefringent medium with a polarizer device according to this invention; and

FIGS. 10-13 are simplified schematic ray diagrams illustrating the optical delay and phase shifting accomplished with the birefringent medium and polarizer of FIG. 9.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

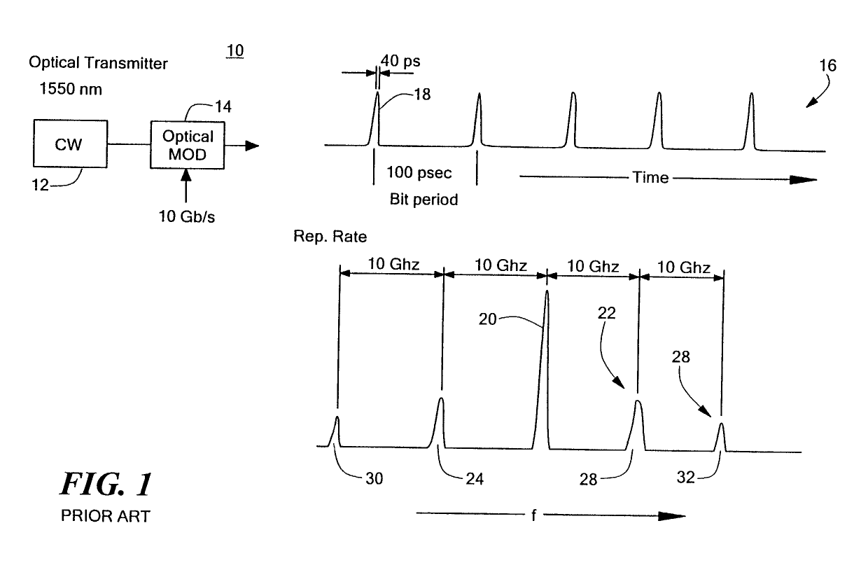

There is shown in FIG. 1 a conventional optical transmitter 10 including a continuous wave laser 12 which may operate at 1550 nm and an optical modulator 14 which may modulate the continuous wave output from laser 12 at a rate of 10 Gb/s. This produces a pulse stream 16 in which each pulse 18 may have a pulse width τ of 40 ps and a bit period of 100 ps corresponding to the 10 Gb/s modulation. In the frequency domain, pulse stream 16 is represented by a transmission band 20 and pairs of side bands the first side pair of side bands 22 includes side bands 24 and 26. The second pair of side bands 28 includes side bands 30 and 32. In the frequency domain the distance between the main transmission band 20 and the first side bands 24 and 26 are, respectively, 10 GHz while the separation between the transmission band 20 and the second side bands 30 and 32 is an additional 10 GHz or 20 GHz. Thus, the entire extent of the first side band 22 is 20 GHz from side band 24 to side band 26 and the full extent of the second side band 28 from side band 30 to side band 32 is 40 GHz.

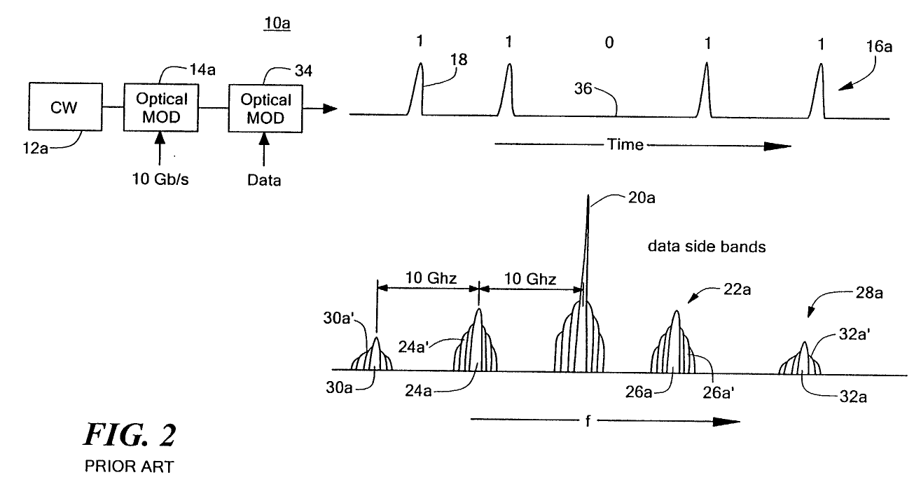

When data is modulated onto the output from optical modulator 14a, FIG. 2, using a second optical modulator 34, the pulse stream 16a comes to represent ones and zeros, as indicated, where the presence of a pulse 18 indicates a one and the absence, such as in the area 36 indicates a zero in the time domain. In the frequency domain, once again, there is a fundamental or transmission band 20a and pairs of side bands 22a and 28a including side bands 24a, 26a, and 30a, 32a respectively. However, in addition, since there has been a modulation of data on the pulse stream there are now data side bands indicated at 24a′, 26a′ and 30a′ and 32a′.

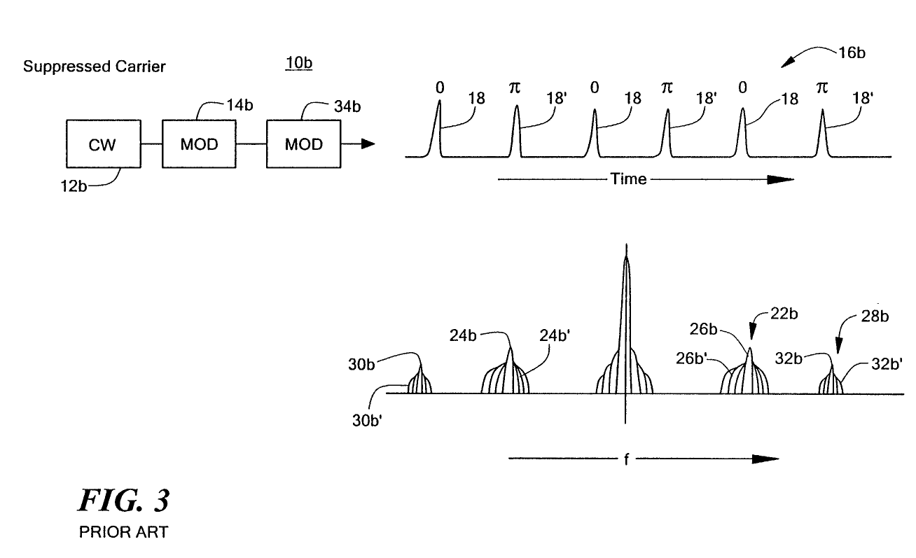

As explained in the background section previously, it is desirable to reduce or remove these sidebands as they contain redundant information and unnecessarily increase the bandwidth required. One approach to the problem is known as the single sideband approach, FIG. 3. This suppresses one side band on each pair of side bands so that the signal carries only side bands on one side thereby effectively halving the bandwidth required. This is shown in the frequency domain where the side bands 26b, 26b′, and 32b, 32b′ have been eliminated while the other side bands 24b, 24b′, 30b, 30b′ of the side band pairs 22b and 28b still exist.

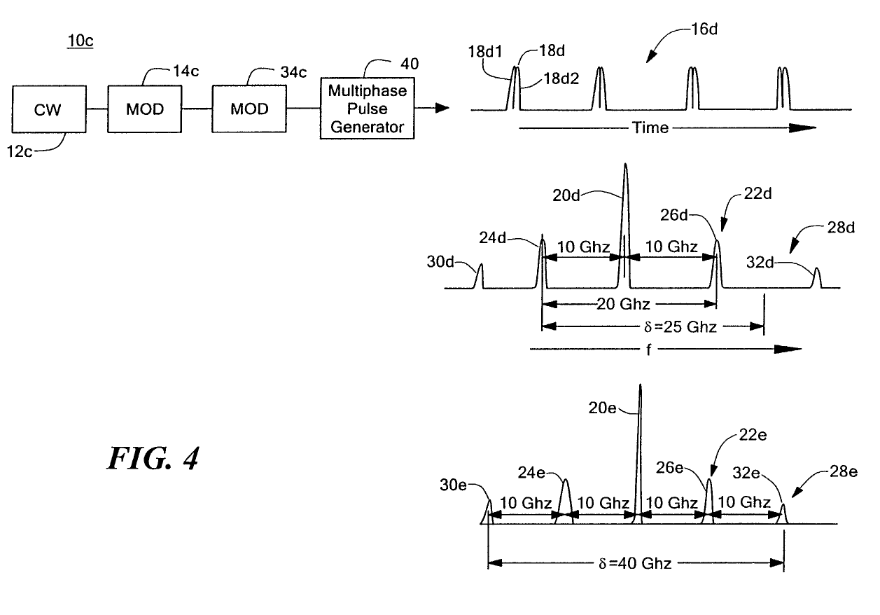

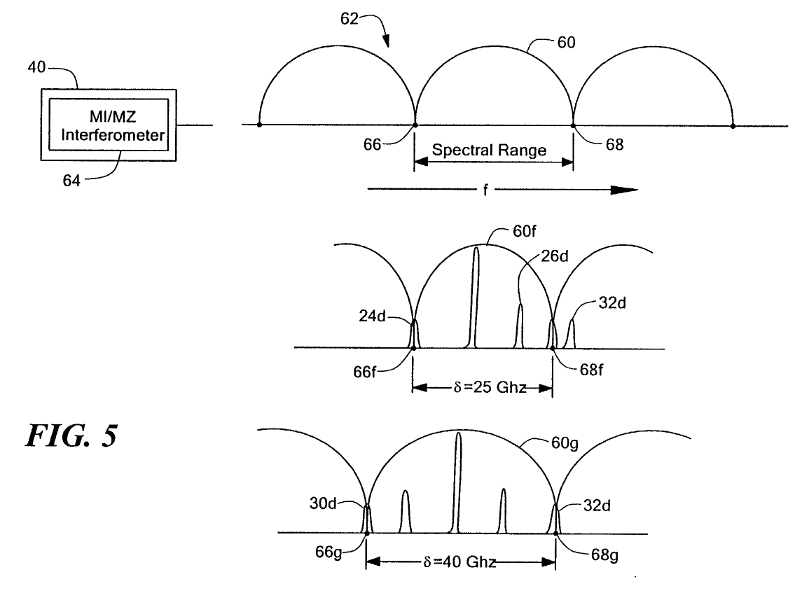

In accordance with this invention a multiphase pulse generator 40, FIG. 4 is added to the optical transmitter 10c to develop a multiphase pulse which has a different phase polarity across its width. Then all non linear effects generated by the left portion of the multiphase pulse are counterbalanced substantially with the right portion of the pulse and they will be interfered to cancel each other out. Although the specific embodiment disclosed herein is illustrated with respect to a single sideband suppression (SSB) approach this is not a limitation of the invention, for it is equally applicable to return-to-zero (RZ), non- return-to-zero (NRZ), carrier suppressed return-to-zero (CS RZ), and other formats as covered by the claims. Pulse stream 16d illustrates the multiphase pulses 18d composed in this instance of just two pulses 18d1 and 18d2. By introducing the proper optical delay and phase shift either one or both of a pair of side bands can be suppressed. For example, in the frequency domain, when it is desired to suppress side band 24d of side band pair 22d, a delay δ of something well beyond the 20 GHz separation of side bands 24d and 26d is chosen, for example 25 GHz as shown. If one wanted to target both side bands 24d and 26d for suppression then one would choose δ equal to exactly 20 GHz. Or for example, if one targeted both side bands 30c and 32e of side band pair 28e then one would set the delay, δ, to exactly 40 GHz to coincide with the 40 GHz separation of side bands 30e and 32e in side band pair 28e. By setting the delay, δ, properly, one can determine the size of the spectral range 60, FIG. 5, of the transform 62 produced by the interferometer 64 included in multiphase pulse generator 40. The interferometer may be a Mach Zehnder or a Michelson interferometer. The proper selection of δ then properly sizes the spectral range 60 so that the null points 66, 68, for example, occur exactly at 25 GHz or 40 GHz depending upon the side band suppression desired. And with the proper phase shift induced in accordance with this invention the spectral range 60 can be aligned so that the null points fall or do not fall on the selected or not selected side bands. For example, in FIG. 5 a spectral range 60f of 25 GHz is aligned by the proper phasing so that null point 66f aligns exactly with side band 24d and suppresses it while null point 68f falls between side bands 26d and 32d and suppresses neither. In contrast, with spectral range 60g of 40 GHz and proper phase Φ, the null points 66g and 68g will align with side bands 30d and 32d suppressing both of them.

One way to generate a multiphase pulse from a single ordinary pulse is by pulse replication and optical delay. The multiphase pulse could be created in its simplest form using a pair of pulses delayed by a predetermined amount by a Mach Zehnder inteferometer or a Michelson interferometer, for example, generating a binary phase pulse. The phase Φ between the pulses is a function of data rate, B (bit period or repetition rate) and the optical delay δ which may be a multiple of one half of the pulse duration τ typically measured at full width at half maximum (FWHM). The phase in degrees can be set according to the formula:

$$φ = \pm ( \frac{δ}{B} ) {360}^{°} or \pm [ ( \frac{δ}{B} ) {360}^{°} - {180}^{°} ] \qquad ( 1 )$$

for example, where the optical delay, δ, is the reciprocal of the frequency separation in the frequency domain. Where the frequency separation desired is 25 GHz as shown in FIGS. 4 and 5 with respect to the suppression of side band 24d, the formula operates as follows:

$$\begin{matrix}φ = \pm ( \frac{\frac{1}{25 GHz}}{100 ps} ) {360}^{°} & ( 2 ) \\ φ = \pm ( \frac{40}{100} ) {360}^{°} & ( 3 ) \\ φ = \pm {144}^{°} or & ( 4 ) \\ φ = \pm [ ( \frac{\frac{1}{25 GHz}}{100 ps} ) {360}^{°} - {180}^{°} ] = \pm {36 }^{°} & ( 4 a ) \\ φ = \pm {{144}^{°}}_{( lead )} / {\pm {36}^{°}}_{( lag )} & ( 5 )\end{matrix}$$

Or where the optical delay δ is 40 GHZ as shown in FIGS. 4 and 5 to suppress both side bands 30d and 32d, Φ can be calculated as follows:

$$\begin{matrix}φ = \pm ( \frac{\frac{1}{40 GHz}}{100 ps} ) {360}^{°} or & ( 6 ) \\ φ = \pm [ ( \frac{\frac{1}{40 GHz}}{100 ps} ) {360}^{°} - {180}^{°} ] & ( 7 ) \\ φ = \pm {90}^{°} & ( 8 ) \\ φ = \pm {90}^{°} & ( 9 )\end{matrix}$$

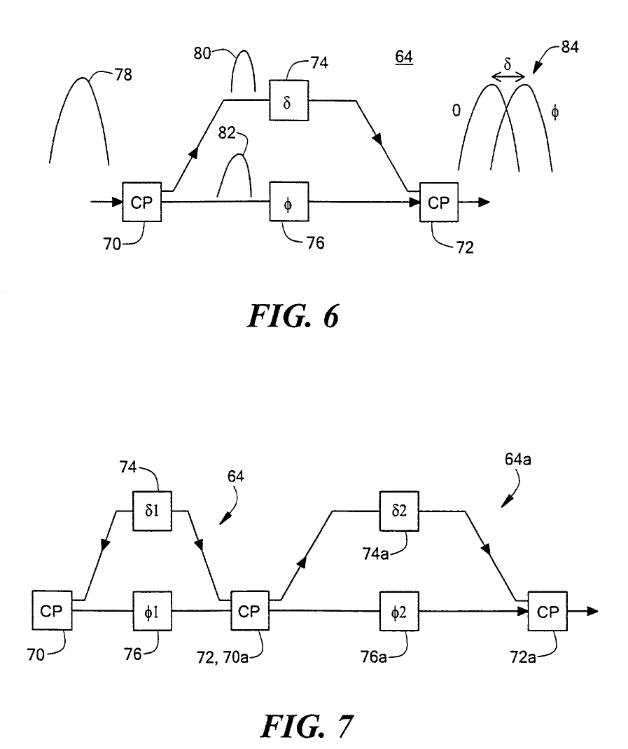

In one embodiment the interferometer 64, FIG. 6 may include an input coupler 70, an output coupler 72, an optical delay device 74 and a phase shifting device 76. The original pulse 78 from a pulse stream is split by coupler 70 into two replica pulses 80 and 82. Replica pulse 80 undergoes an optical delay δ by delay device 74 with respect to replica pulse 82, while replica pulse 82 undergoes a phase shift Φ from phase shift device 76 relative to replica pulse 80. When the two are then combined by output coupler 72, the result is a multiphase pulse 84 having an optical delay δ and phase shift Φ which satisfies the formula and will produce the spectral range of the right size and properly aligned to suppress one and only one or both of a selected pair of side bands.

Interferometers may be cascaded so that a number of different side band pairs may be targeted for suppression of one or both of their side bands. For example, as shown in FIG. 7, interferometer 64a is cascaded with an additional interferometer 86, so that first one side band pair may be targeted and then another, for example, interferometer 64 may be set for an optical delay δ and phase shift Φ to suppress side band 24d, while interferometer 64a may have its optical delay δ, and phase shift Φ set to suppress both side bands 30d and 32d. Although in the discussion thus far, one replica pulse is delayed relative to the other to accomplish the optical delay and the other replica pulse is phase shifted to accomplish the phase shift between it and the first pulse, this is not a necessary limitation of the invention. For example, both the delay and the phase shift may be accomplished on one of the replica pulses and neither the phase shift nor the optical delay imposed on the other.

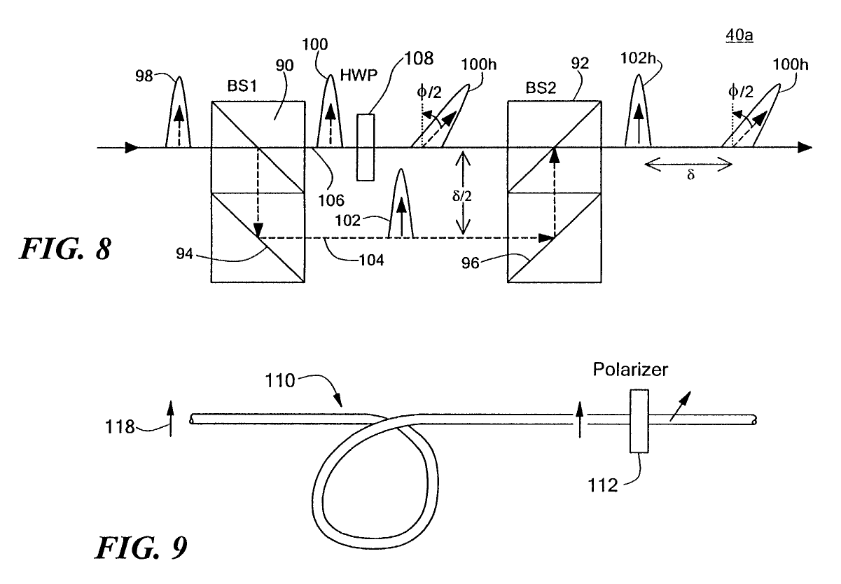

The multiphase pulse according to this invention can also be generated by a series of pulses with different states of polarization. The delay in these pulses is preferably a multiple of ½ of FWHM of the original pulse duration, while the angle of the polarization axes of the pulses is set by half the value set forth in equation (1). This may be accomplished by the multiphase pulse generator 40a, FIG. 8 which includes beam splitters 90 and 92 and deflectors or mirrors 94 and 96. Here the initial pulse 98 is split into two replica pulses 100 and 102 by beam splitter 90. The second replica pulse is reflected by mirror 94 along the path 104 from which it is returned from mirror 96 and beam splitter 92 in order to produce the optical delay δ. In this case the actual delay produced by the optics is δ/2. Replica pulse 100, in the meantime, moves along path 106 where polarization rotator 108 such as a halfway plate introduces a polarization rotation of Φ/2. The optically delayed replica pulse 102h and the phase shifted replica pulse 100h are then produced at the output by beam splitter 92 where those two output pulses constitute a multiphase pulse where the two pulses have a separation of the optical delay δ plus a polarization rotation of Φ/2.

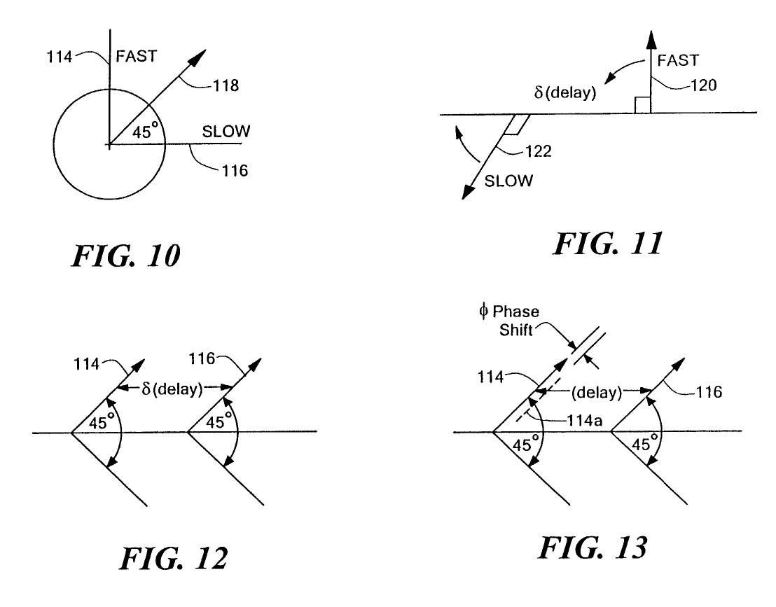

The implementation of this invention is not limited to a common interferometer. For example, it may be implemented using a birefringent medium 110, FIG. 9 and a polarizer 112. The birefringent medium 110 has a fast axis 114, FIG. 10, and a slow axis 116. If then the input pulse 118, FIG. 9 is introduced not aligned with either fast 114 or slow 116 axis but between them at 45°, FIG. 10, the pulse will be resolved into two replica pulses, 120 on the fast axis and 122, FIG. 11, on the slow axis. The delay introduced between the fast and slow axis provides the optical delay δ while the polarizer 112 realigns both replica pulse 114 and 116, FIG. 12, from their orthogonal positions along the slow and fast axis. By a slight rotation of polarizer 112 for example from 45° to 44° a phase shift can be introduced, FIG. 13, as shown by the repositioning of replica pulse 114a shown in phantom. The phase shift is not restricted to the use of a polarizer, for example the application of a stress to birefringent medium 110 would also function to introduce the required phase Φ. The birefringent medium may be any of a number of devices such as a polarization maintaining fiber, or a calcite, lithium niobate, or yitrium orthovanadate material. In addition, although with respect to FIGS. 9-13 the illustration has been with respect to a linear birefringent embodiment, this is not a necessary limitation of the invention as medium 110 may be a circular birefringent material such as quartz or other circular birefringent fibers and polarizer 112 may be a circular polarizer.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A multiphase optical pulse generator for selective side band suppression of a pulse stream comprising:
an unbalanced interferometer responsive to a pulse of said pulse stream to generate at least first and second replica pulses, a delay device for delaying said replica pulses relative to each other to define a free spectral range to include only one or both of a pair of selected spectral side bands to be suppressed, a phase shifting device for shifting the phase of said replica pulses relative to each other to align the free spectral range and create a combined multiphase pulse to suppress said only one or both of said selected spectral side bands.

2. The multiphase optical pulse generator of claim 1 in which said interferometer is a Mach Zehnder interferometer.

3. The multiphase optical pulse generator of claim 1 in which said interferometer is a Michelson interferometer.

4. The multiphase optical pulse generator of claim 1 in which said interferometer includes an input coupler for generating said replica pulses.

5. The multiphase optical pulse generator of claim 1 in which said interferometer includes an output coupler for recombining said delayed and phase shifted replica pulses into said multiphase pulse.

6. The multiphase optical pulse generator of claim 1 in which said interferometer includes a first beam splitter for generating said replica pulses, a second beam splitter for recombining said replica pulses, a first mirror for directing said first replica pulse over a delay path to a second mirror which directs said first replica pulse to said second beam splitter, and a polarization rotator between said first and second beam splitter to shift the phase of said second pulse relative to said first replica pulse.

7. The multiphase optical pulse generator of claim 1 in which said polarization rotator includes a half wave plate.

8. The multiphase optical pulse generator of claim 1 in which said interferometer includes a birefringent optical medium.

9. The multiphase optical pulse generator of claim 8 in which said birefringent optical medium resolves an incoming pulse into time delayed orthogonal replica pulses.

10. The multiphase optical pulse generator of claim 9 in which said interferometer includes a polarizer for phase shifting said orthogonal replica pulses and combining them into said multiphase pulse.
